(19) United States
(12) Patent Application Publication
(10) Pub. No.: US 2005/0236725 A1
(43) Pub. Date: Oct. 27, 2005

(54) Method and apparatus for countering mold deflection and misalignment using active material elements

(76) Inventors: Joachim Johannes Niewels, Thornton (CA); Zbigniew Romanski, Mississauga (CA); Robin A. Arnott, Alliston (CA)

Correspondence Address: KATTEN MUCHIN ROSENMAN LLP, 525 WEST MONROE STREET, CHICAGO, IL, 60661-3693, US

(21) Appl. No.: 10/830,434

(22) Filed: Apr. 23, 2004

(51) Int. Cl. B29C 45/76; B29C 45/80

(52) U.S. Cl. 264/40.1; 264/328.1; 425/149

(57) ABSTRACT

Method and apparatus for controlling an injection mold having a first surface and a second surface includes an active material element configured to be disposed between the first surface and a second surface. The active material element may be configured to sense a force between the first surface and the second surface, and to generate corresponding sense signals. Transmission structure is coupled to the active material element and is configured to carry the sense signals. Preferably, an active material element actuator is also disposed between the first surface and a second surface, and is configured to provide an expansive force between the first surface and a second surface in accordance with the sense signals. The method and apparatus may be used to counter undesired deflection and/or misalignment in an injection mold.

### BACKGROUND OF THE INVENTION

1. Field of the Invention

The present invention relates to a method and apparatus for countering mold deflection and mold misalignment, in which active material elements are used in injection molding machine equipment (e.g., insert stacks), in order to detect and/or counter deflections in the mold structure. “Active materials” are a family of shape altering materials such as piezoactuators, piezoceramics, electrostrictors, magnetostrictors, shape memory alloys, and the like. In the present invention, they are used in an injection mold to counter deflections in the mold structure and thereby improve the quality of the molded article, the life of the mold components, and improve resin sealing. The active material elements may be used as sensors and/or actuators.

2. Related Art

Active materials are characterized as transducers that can convert one form of energy to another. For example, a piezoactuator (or motor) converts input electrical energy to mechanical energy causing a dimensional change in the element, whereas a piezosensor (or generator) converts mechanical energy—a change in the dimensional shape of the element—into electrical energy. One example of a piezoceramic transducer is shown in U.S. Pat. No. 5,237,238 to Berghaus. Marco Systemanalyse und Entwicklung GmbH is a supplier of peizoactuators located at Hans-Böckler-Str. 2, D-85221 Dachau, Germany, and their advertising literature and website illustrate such devices. Typically, an application of 1,000 volt potential to a piezoceramic insert will cause it to “grow” approximately 0.0015″/inch (0.15%) in thickness. Another supplier, Midé Technology Corporation of Medford, Maine, has a variety of active materials including magnetostrictors and shape memory alloys, and their advertising literature and website illustrate such devices, including material specifications and other published details.

FIG. 1 shows a schematic representation of a multi-cavity preform mold. The injected molten plastic enters through a sprue bush 10, and is subdivided into channels contained in multiple manifolds 11 leading to individual nozzles 12 for each mold cavity 13. The manifolds 11 are contained in cutouts made in the manifold plate 14 and the manifold backing plate 15. While there are usually supports (not shown) extending through the manifold structures connecting the manifold plate 14 and the manifold backing plate 15, the combined structure of this half of the mold is less rigid than is desirable.

FIG. 2 illustrates, in an exaggerated representation, the way the manifold plate 11 may deflect at 16 under molding conditions. The effect of this deflection is to unequally support the multiple molding stacks 17 thereby producing parts of varying quality from each stack. It is desirable to provide a means to minimize manifold plate deflection and provide equalized support for all the molding stacks.

U.S. Pat. No. 4,556,377 to Brown discloses a self-centering mold stack design for thin wall applications. Spring loaded bolts are used to retain the core inserts in the core plate while allowing the core inserts to align with the cavity half of the mold via the interlocking tapers. While Brown discloses a means to improve the alignment between core and cavity and to reduce the effects of core shift (“offset”), there is no disclosure of actually measuring and then correcting such shifting, in a proactive manner.

### SUMMARY OF THE INVENTION

It is an advantage of the present invention to provide injection molding machine apparatus and method to overcome the problems noted above, and to provide an effective, efficient means for detecting and/or correcting deflection and misalignment in a mold provided in an injection molding machine.

According to a first aspect of the present invention, structure and/or function are provided for an injection mold having a core and a core plate. An active material sensor is configured to be disposed between the core and the core plate and configured to sense a force between the core and the core plate and to generate corresponding sense signals. Wiring structure is coupled, in use, to the active material sensor and configured to carry the sense signals.

According to a second aspect of the present invention, structure and/or function are provided for a control apparatus for an injection mold having a first surface and a second surface. An active material sensor is configured to be disposed between the first surface and the second surface of the injection molding machine, for sensing a compressive force between the first surface and the second surface and generating a corresponding sense signal. Transmission structure is configured to transmit, in use, the sense signal from the active material sensor.

According to a third aspect of the present invention, structure and/or steps are provided for controlling deflection between first and second surfaces of an injection molding machine. A piezoceramic actuator is configured to be disposed between the first and second surfaces of the injection molding machine, for receiving an actuation signal, and for generating an expansive force between the first and second surfaces. Transmission structure is configured to transmit an actuation signal to the piezoceramic actuator.

### BRIEF DESCRIPTION OF THE DRAWINGS

Exemplary embodiments of the presently preferred features of the present invention will now be described with reference to the accompanying drawings in which:

FIG. 1 is a schematic representation of a multicavity preform mold;

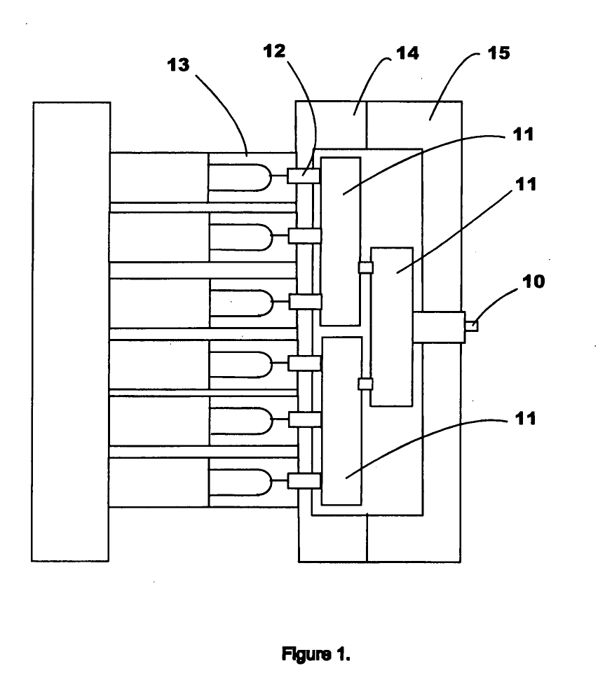

FIG. 2 is a schematic representation of a multicavity preform mold being deflected by injection pressure while under machine clamping;

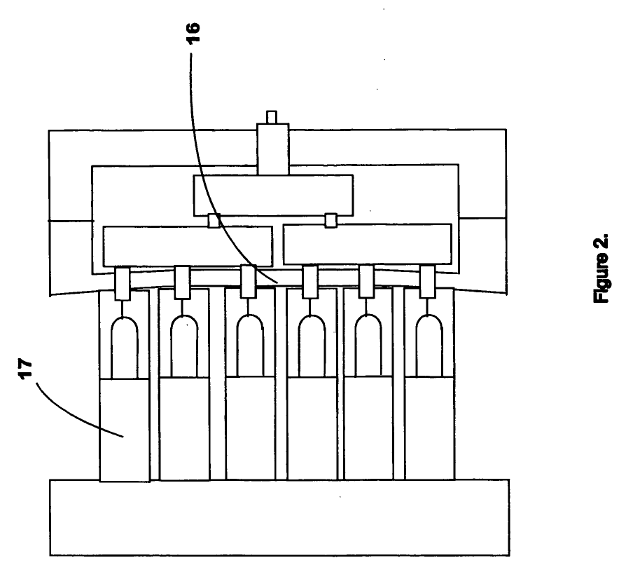

FIG. 3 is a schematic representation of a core lock style preform molding stack incorporating an embodiment according to the present invention;

FIG. 4 is a schematic representation of a cavity lock style preform molding stack incorporating an embodiment according to the present invention;

FIG. 5 is a schematic representation of a typical thinwall container molding stack exhibiting the core shift problem;

FIG. 6 is a schematic representation of a typical thinwall container molding stack incorporating an embodiment according to the present invention;

FIG. 7 is a schematic representation of a plan view of the thinwall container molding stack incorporating an embodiment according to the present invention; and

FIG. 8 is a schematic representation of a typical thinwall container molding stack incorporating another embodiment of the present invention.

### DETAILED DESCRIPTION OF THE PRESENTLY PREFERRED EXEMPLARY EMBODIMENTS

1. Introduction

The present invention will now be described with respect to several embodiments in which active material elements serve to detect and/or correct deflection and misalignment in an injection mold. However, the active material sensors and/or actuators may be placed in any location in the injection molding apparatus in which alignment and/or sealing problems could be encountered. Other applications for such active material elements are discussed in the related applications titled (1) “Method and Apparatus for Assisting Ejection from an Injection Molding Machine Using Active Material Elements”, (2) “Method and Apparatus for Providing Adjustable Hot Runner Assembly Seals and Tip Height Using Active Material Elements”, (3) “Method and Apparatus for Controlling a Vent Gap with Active Material Elements”, (4) “Method and Apparatus for Mold Component Locking Using Active Material Elements”, (5) “Methods and Apparatus for Vibrating Melt in an Injection Molding Machine Using Active Material Elements”, (6) “Method and Apparatus for Injection Compression Molding Using Active Material Elements”, and (7) “Control System for Utilizing Active Material Elements in a Molding System”, all of which are being filed concurrently with the present application.

In the following description, piezoceramic inserts are described as the preferred active material. However, other materials from the active material family, such as magnetostrictors and shape memory alloys, could also be used in accordance with the present invention. A list of possible alternate active materials and their characteristics is set forth below in Table 1, and any of these active materials could be used in accordance with the present invention:

TABLE 1
Comparison of Active Materials

| | Temperature | Nonlinearity | Structural | Cost/Vol. | Technical |
|---|---|---|---|---|---|
| Material | Range (° C.) | (Hysteresis) | Integrity | ($/cm3) | Maturity |
| Piezoceramic | −50-250 | 10% | Brittle | 200 | Commercial |
| PZT-5A | | | Ceramic | | |
| Piezo-single | — | <10% | Brittle | 32000 | Research |
| crystal TRS-A | | | Ceramic | | |
| Electrostrictor | 0-40 | Quadratic <1% | Brittle | 800 | Commercial |
| PMN | | | Ceramic | | |
| Magnetostrictor | −20-100 | 2% | Brittle | 400 | Research |
| Terfenol-D | | | | | |
| Shape Memory | Temp. | High | OK | 2 | Commercial |
| Alloy Nitinol | Controlled | | | | |
| Magn. Activated | <40 | High | OK | 200 | Preliminary |
| SMA NiMnGa | | | | | Research |
| Piezopolymer | −70-135 | >10% | Good | 15* | Commercial |
| PVDF | | | | | |

(information derived from www.mide.com)

### 2. The Structure of the First Embodiment

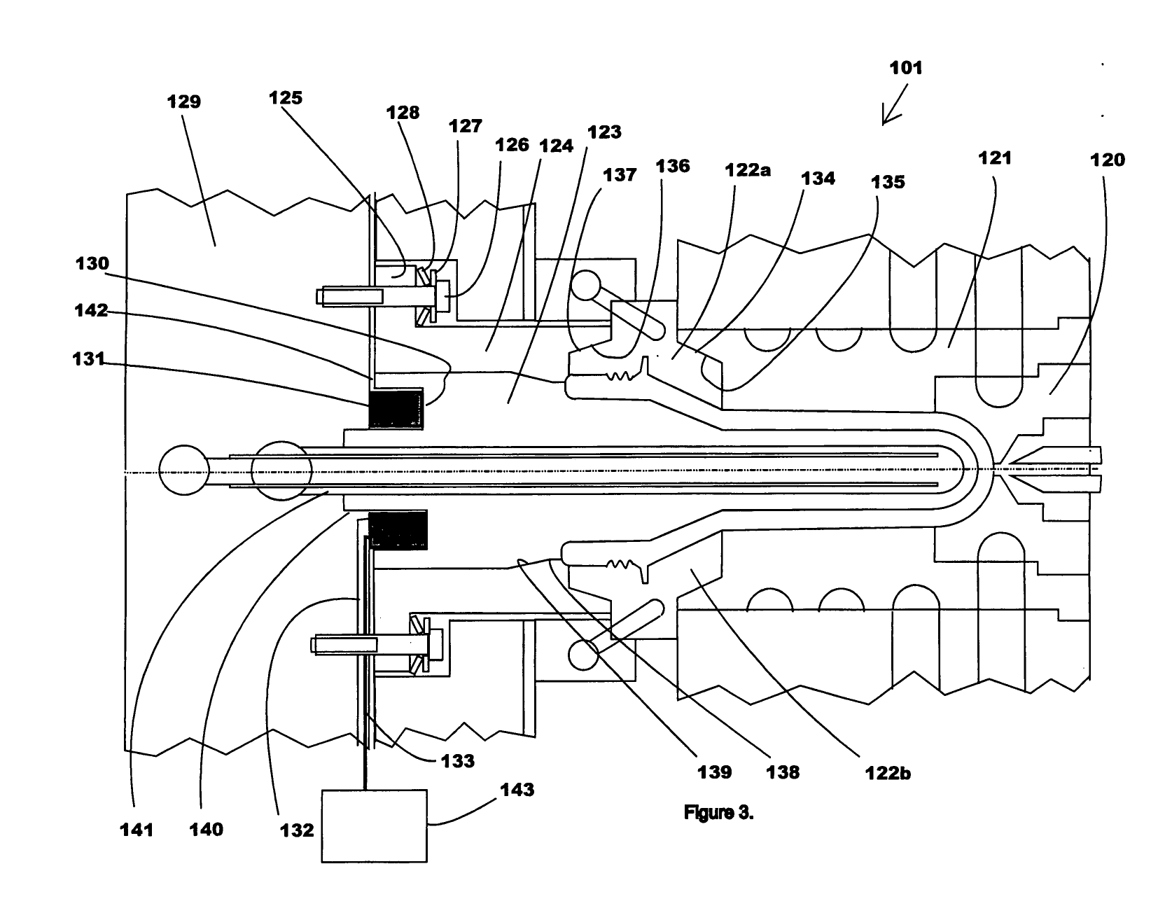

The first preferred embodiment of the present invention is shown in FIG. 3, which depicts an injection molding machine preform molding stack 101 of the core lock style. The stack comprises a gate insert 120, a cavity 121, neck ring halves 122a and 122b, a core 123, and a core sleeve 124. The core sleeve 124 has a flange 125 through which several spring loaded fasteners (including, e.g., a bolt 126, a washer 127, and a spring washer (Belleville) 128) are used to fasten the sleeve to the core plate 129. The core 123 has an annular channel 130 in its base to accept an annular shaped piezoceramic element 131. The core plate 129 has a wire groove 132 to accept wiring connections 133 to the element 131. The piezoceramic element 131 may also be driven by wireless means (not shown).

The piezo-electric element 131 may comprise a piezo-electric sensor or a piezo-electric actuator (or a combination of both), and may, for example, comprise any of the devices manufactured by Marco Systemanalyse und Entwicklung GmbH. The piezo-electric sensor will detect the pressure applied to the element 131 and transmit a corresponding sense signal through the wiring connections 133. The piezo-electric actuator will receive an actuation signal through the wiring connections 133 and apply a corresponding force between the core plate 129 and the core 123. Note that more than one piezo-electric sensor may be provided to sense pressure from any desired position in the annular groove 130 (or any other desired location). Likewise, more than one piezo-electric actuator may be provided, mounted serially or in tandem with each other and/or with the piezo-electric sensor, in order to effect extended movement, angular movement, etc., of the core 123 with respect to the core plate 129.

The piezoceramic actuator is preferably a single actuator that is annular or cylindrical in shape. According to a presently preferred embodiment, the actuator increases in length by approximately 0.15% when a voltage of 1000 V is applied via wiring 233. However, use of multiple actuators and/or actuators having other shapes are contemplated as being within the scope of the invention, and the invention is therefore not to be limited to any particular configuration of the piezoceramic actuator.

Preferably, one or more separate piezoceramic sensors may be provided adjacent the actuator (or between any or the relevant surfaces described above) to detect pressure caused by injection of the plastic. Preferably, the sensors provide sense signals to the controller 143. The piezo-electric elements used in accordance with the preferred embodiments of the present invention (i.e., the piezo-electric sensors and/or piezo-electric actuators) may comprise any of the devices manufactured by Marco Systemanalyse und Entwicklung GmbH. The piezo-electric sensor will detect the pressure applied to the actuator and transmit a corresponding sense signal through the wiring connections 133, thereby allowing the controller 143 to effect closed loop feedback control. The piezo-electric actuator will receive an actuation signal through the wiring connections 133, change dimensions in accordance with the actuation signal, and apply a corresponding force to the adjacent mold component, adjustably controlling the mold deflection.

Note that the piezo-electric sensors may be provided to sense pressure at any desired position. Likewise, more than one piezo-electric actuator may be provided, mounted serially or in tandem, in order to effect extended movement, angular movement, etc. Further, each piezo-electric actuator may be segmented into one or more arcuate, trapezoidal, rectangular, etc., shapes which may be separately controlled to provide varying sealing forces at various locations between the sealing surfaces. Additionally, piezo-electric actuators and/or actuator segments may be stacked in two or more layers to effect fine sealing force control, as may be desired.

The wiring connections 133 may be coupled to any desirable form of controller or processing circuitry 143 for reading the piezo-electric sensor signals and/or providing the actuating signals to the piezo-electric actuators. For example, one or more general-purpose computers, Application Specific Integrated Circuits (ASICs), Digital Signal Processors (DSPs), gate arrays, analog circuits, dedicated digital and/or analog processors, hard-wired circuits, etc., may control or sense the piezo-electric element 131 described herein. Instructions for controlling the one or more processors may be stored in any desirable computer-readable medium and/or data structure, such floppy diskettes, hard drives, CD-ROMs, RAMs, EEPROMs, magnetic media, optical media, magneto-optical media, etc.

Use of the piezoceramic elements according to the present embodiment allows the various components of the injection mold assembly described above to be manufactured to lower tolerance, thereby decreasing the cost of manufacturing the injection molding machine components themselves. Previously, tolerances of 5-10 microns were used in order to achieve a functional injection mold. Further benefits include the ability to adjust the alignment of the mold components, thereby preventing mold deflection and reducing the length of any equipment down time.

### 3. The Process of the First Embodiment

In operation, when the mold is closed and clamping tonnage is applied to the mold, the molding stack 101 aligns its components as follows. The gate insert 120 is fitted within the cavity 121 by locating diameters (not shown), the cavity female taper 134 aligns the corresponding male taper 135 on the neck ring inserts 122a, 122b, the neck ring male taper 136 aligns the corresponding female taper 137 in the core sleeve 124, and the core sleeve inner female taper 138 aligns the core male taper 139. The core sleeve 124 and core 123 are able to shift to conform to this taper alignment method since the spring loaded fastening means (biasing means) at the base of the core sleeve 124 allow a slight movement and the core spigot 140 has a corresponding clearance in the core base 129 without jeopardizing the sealing of the core cooling circuits 141. Element 131 is preferably slightly thicker than the depth of its annular groove 130 so that when assembled there is a slight gap 142, typically less than 0.1 mm, between the base of the core 123 and the core plate 129.

While clamped, and during injection of the resin into the cavity, and as injection pressure builds and is maintained inside the cavity, the injection pressure acts on the projected area of the core and core sleeve to exert a force toward the core plate that element 131 senses as a compressive load. The insert will transmit an electronic signal that preferably varies according to the force applied to it. This signal is transmitted to a device (not shown) that processes the signal for communication to a controller 143 that determines if a command signal should be transmitted for countering the compressive load. For example, command signals can be transmitted to adjust the clamping force or injection pressure or injection rate to alter the conditions in the mold cavity.

Alternately, the element 131 may be used as a motor (force generator) wherein electrical power is supplied to (or removed from) the element 131, causing it to expand (or contract) in size and thereby adjust the height of the mold stack 101. In this embodiment, the element 131 preferably comprises an annular cylinder between 55-75 mm in length which will generate an increase in length of about 0.1 mm when approximately 1000 V is applied to it. By individually controlling the height of each stack 101, variations in the stiffness of the mold structure as a whole and the deflection of the manifold plate 114 in particular can be made. For example, in this embodiment, all elements 131 (one per molding stack) may be subjected to the same voltage so that a balanced load distribution among the stacks occurs, provided that the individual height adjustments of the stacks is within the operating range of each element, in this embodiment typically less than 0.1 mm.

### 4. The Structure of the Second Embodiment

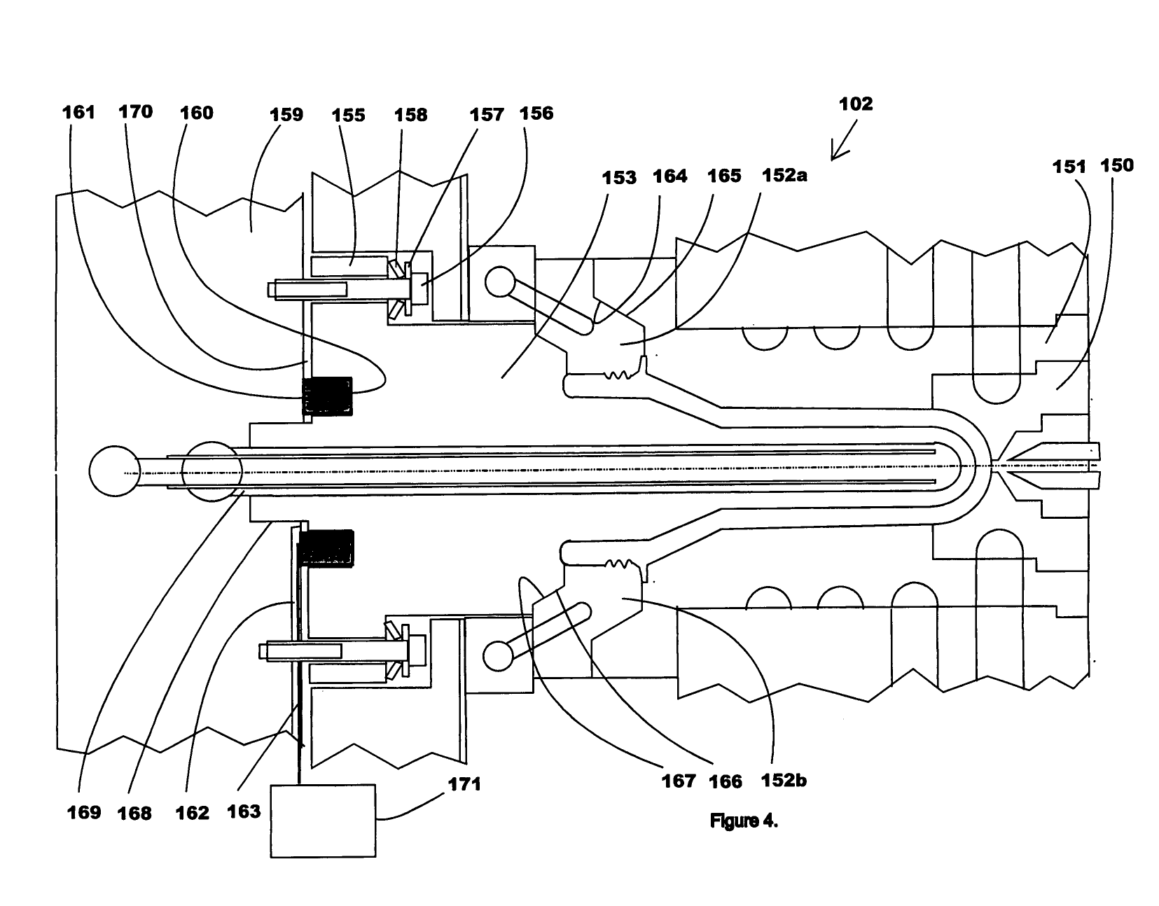

FIG. 4 shows an alternate preform molding stack 102 for a cavity lock style stack. The stack comprises a gate insert 150, a cavity 151, neck ring halves 152a and 152b, and a core 153. The core 153 has a flange 155 through which several spring loaded fasteners (e.g., a bolt 156, a washer 157, and a spring washer (Belleville) 158) are used to fasten the core 153 to the core plate 159. The core 153 has an annular channel 160 in its base to accept an annular shaped piezoceramic insert 161. The core plate 159 has a wire groove 162 to accept wiring connections 163 to the element 161, and the wiring connections 163 may optionally be connected to a controller 171. There is a similar assembly gap 170, typically less than 0.1 mm.

Optionally, one or more separate piezoceramic sensors may be provided to detect pressure caused by positional changes within the mold. These sensors may also be connected by conduits 163 to the controller 171. The piezo-electric elements 161 used in accordance with the present invention (i.e., the piezo-electric sensors and/or piezo-electric actuators) may comprise any of the devices manufactured by Marco Systemanalyse und Entwicklung GmbH. The piezo-electric sensors can detect the pressure at various interfaces within the nozzle assembly and transmit a corresponding sense signal through the conduits, thereby effecting closed loop feedback control. The piezo-electric actuators then receive actuation signals through the conduits, and apply corresponding forces. Note that piezo-electric sensors may be provided to sense pressure from any desired position. Likewise, more than one piezo-electric actuator may be provided in place of any single actuator described herein, and the actuators may be mounted serially or in tandem, in order to effect extended movement, angular movement, etc.

As mentioned above, one of the significant advantages of using the above-described active element inserts 161 is to allow the manufacturing tolerances used for the injection molds to be widened, thereby significantly reducing the cost of machining those features in the mold components.

### 5. The Process of the Second Embodiment

In operation, when the mold is closed and clamping tonnage is applied to the mold, the molding stack 102 aligns its components as follows. The gate insert 150 is fitted within the cavity 151 by locating diameters (not detailed), the cavity female taper 164 aligns the corresponding male taper 165 on the neck ring inserts 152, and the neck ring female taper 166 aligns the corresponding male taper 167 on the core. The core 153 is able to shift to conform to this taper alignment method since the spring loaded fastening means at the base of the core allows a slight movement, and the core spigot 168 has a corresponding clearance in the core base 159 without jeopardizing the sealing of the core cooling circuits 169. The element 161 may be used as a sensor and/or an actuator, as previously described.

### 6. The Structure of the Third Embodiment

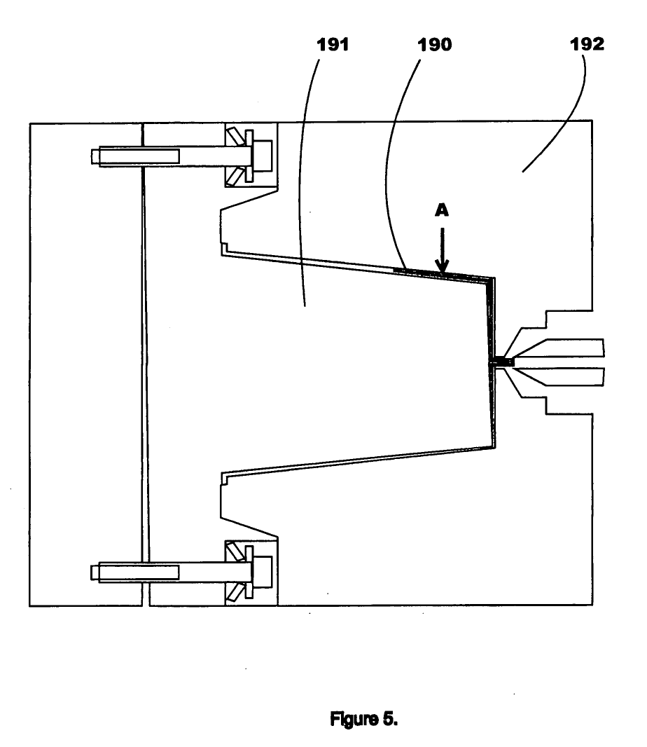

FIG. 5 illustrates one problem that can occur when molding thinwall parts using a molding stack. If the incoming resin flow does not fill the cavity exactly symmetrically (that is, if the flow takes a preferential course 190 when flowing down the sidewalls), resin can exert an unbalancing side force on the core 191, as indicated by arrow A, thereby causing the core to shift within the cavity 192. The subsequent molded part has an unequal sidewall thickness that can be sufficiently thin to cause the part to fail.

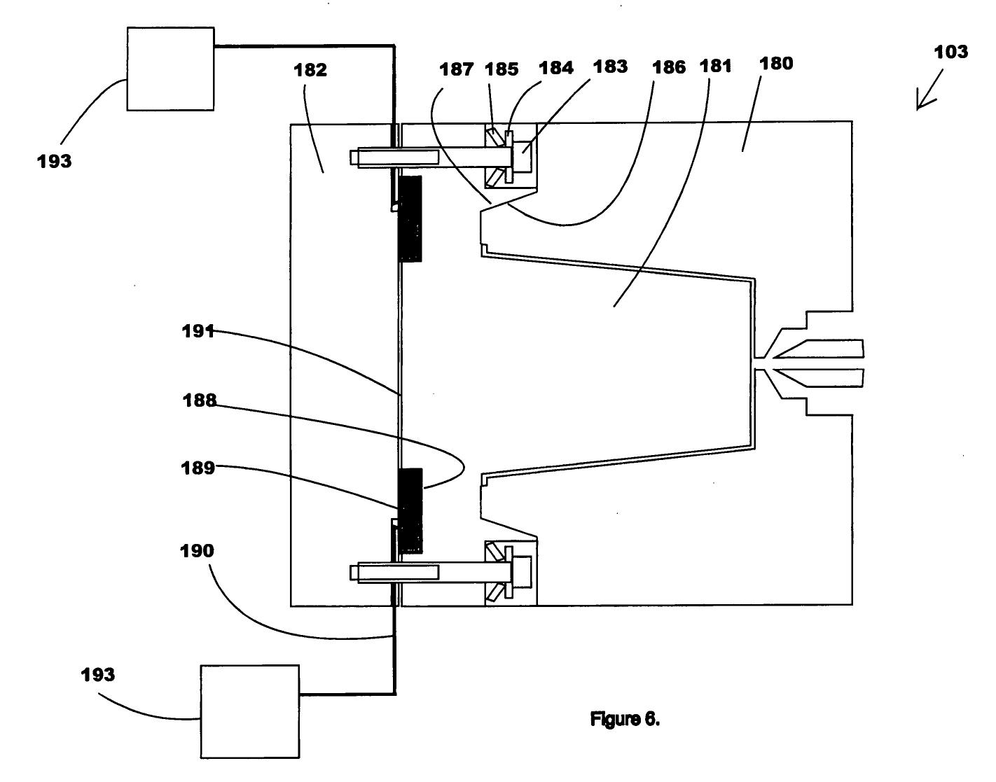

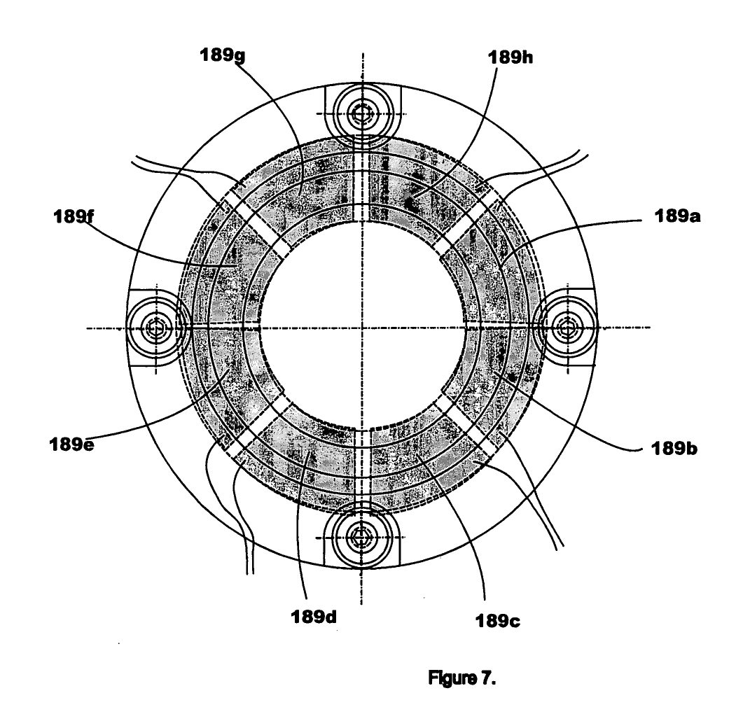

An embodiment for overcoming this problem is shown in FIGS. 6 and 7, which depict a thinwall molding stack 103. The thinwall molding stack 103 includes a cavity 180 and a core 181. The core has several spring loaded fasteners (e.g., a bolt 183, a washer 184, and a spring washer (Belleville) 185) that are used to fasten the core 181 to the core plate 182. A male taper 186 on the cavity is used to align the core 181 via female taper 187. The core can adjust its position relative to the core plate as previously described. Annular recess 188 in the core base is used to house piezoceramic elements 189 that have wiring connections 190. The wiring connections 190 may optionally lead to a controller 193. There is a slight clearance 191 between the base of the core 181 and the core plate 182. FIG. 7 shows a plan view of the core assembly in FIG. 6, and shows the layout of the multiple elements 189 in an annular fashion. Eight elements 189a-h are shown with individual wiring connections. In this embodiment, each element forms an arc of about 45 degrees. Of course, any number of elements with the same or different shapes may be used, as desired.

### 7. The Process of the Third Embodiment

The embodiment shown in FIGS. 6 and 7, and as described above with reference to the core shifting problem, can be countered by selectively energizing one or more of the piezoceramic force generators 189a-h in the base of the core 181. By analyzing the location of the unbalanced sidewall of a previously molded part and determining the direction in which the core has shifted to cause that part to be molded, the appropriate element 189 or combination of elements 189a-h may be energized to exert a countering force against the core, thereby minimizing the core shifting in subsequent molding cycles. By selecting the element 189 or combination of elements 189a-h, and the amount of voltage to be applied to each element, an appropriate countering force (in terms of both intensity and location) can be applied. Subsequent molded parts can be further analyzed to fine tune the countermeasures until the wall thickness of the part is corrected to within acceptable limits.

### 8. The Structure of the Fourth Embodiment

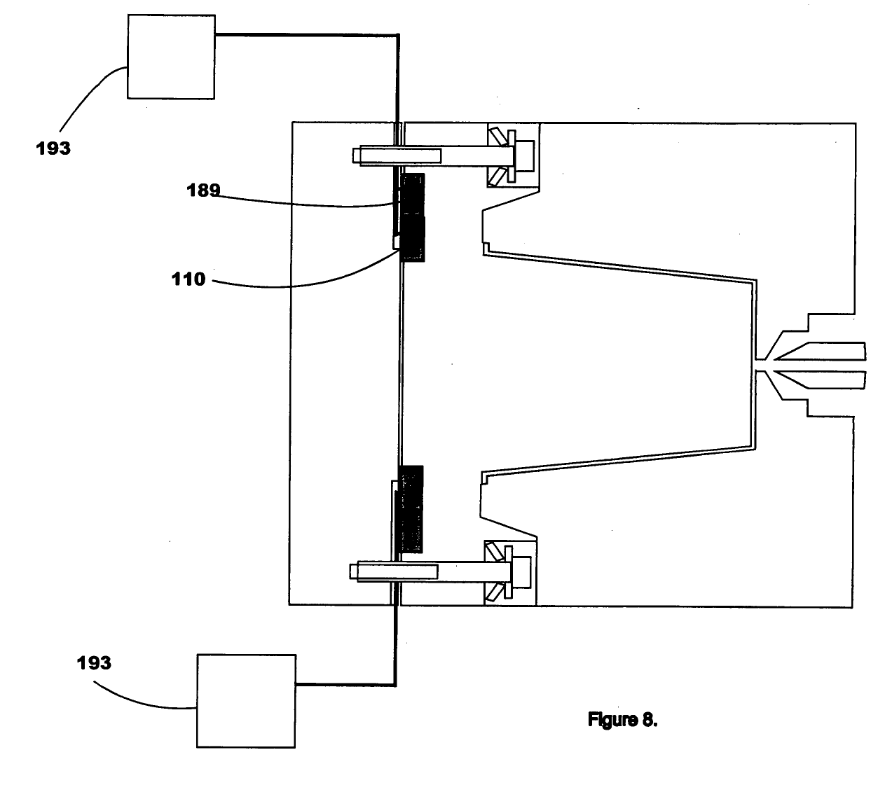

FIG. 8 illustrates a fourth embodiment of the thinwall molding stack configuration that is applicable to the other preferred embodiments presented herein, as well as additional configurations that may be envisioned by those skilled in the art. Sensor elements 110a-h and actuator elements 189a-h are adjacently mounted, and configured so that one element acts as a sensor monitoring the dimensional changes of the other element, which is configured as a motor, so that real-time closed loop control can be effected by simultaneous operation of the two elements. This configuration allows instant detection of unbalanced compressive forces, and promptly corrects them. Each sensor element 110a-h may be used to detect compressive forces between the core and the core plate, and/or the changes in the adjacent piezo-electric actuators 189a-h. When adjacently mounted, these sensors and actuators may also be used to monitor the compressive forces between various injection molding components, as described above.

In this thinwall molding stack embodiment, a group of sensor elements 110a-h are preferably placed next to (radially inside) a group of actuator elements 189a-h. It is within the scope of the present invention to depart from this preferred configuration, for example, by placing the sensor elements radially outside the actuator elements, or in any other configuration that results in a closed-loop feedback system. The sensor elements 110a-h detect any shifting of the core during molding. The signals emitted by the sensors of this group correspond to the amount and location of shifting that is occurring, and the signals are transmitted to a controller 193 that can calculate an appropriate countering energy level to deliver to the actuator elements 189a-h so that a countering force can be applied to substantially correct the core shifting as it occurs. The signal processing and controller performance is sufficiently fast enough to allow this application of corrective measures to effect correction of the core shift in a real time feedback loop.

### 9. CONCLUSION

Thus, what has been described is a method and apparatus for using active material elements in an injecting molding machine, separately and in combination, to effect useful improvements in injection molding apparatus and minimize mold deflection and misalignment.

Advantageous features according the present invention include: 1. An active material element used singly or in combination to generate a force or sense a force in an injection molding apparatus; 2. The counteraction of deflection in molding apparatus by a closed loop controlled force generator; and 3. The correction of core shifting in a molding apparatus by a locally applied force generator exerting a predetermined force computed from data measured from previously molded parts.

While the present invention provides distinct advantages for injection-molded parts generally having circular cross-sectional shapes perpendicular to the part axis, those skilled in the art will realize the invention is equally applicable to other molded products, possibly with non-circular cross-sectional shapes, such as, pails, paint cans, tote boxes, and other similar products. All such molded products come within the scope of the appended claims.

The individual components shown in outline or designated by blocks in the attached Drawings are all well-known in the injection molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents (including the applications discussed in paragraph [0019]) discussed above are hereby incorporated by reference into the Detailed Description of the Preferred Embodiment

1. Apparatus for an injection mold having a core and a core plate, comprising:
an active material sensor configured to be disposed between the core and the core plate, and configured to sense a force between the core and the core plate and to generate corresponding sense signals; and
wiring structure coupled, in use, to said active material sensor and configured to carry the sense signals.

2. Apparatus according to claim 1, wherein said active material sensor comprises a piezo-electric sensor

3. Apparatus according to claim 1, wherein said active material sensor is configured to be disposed in an annular groove in at least one of the core and the core plate.

4. Apparatus according to claim 1, further comprising a plurality of active material sensors configured to be disposed at different locations between the core and the core plate.

5. Apparatus according to claim 1, further comprising a processor configured to receive the sense signals from said active material sensor and to generate at least one of (i) a clamping force signal, (ii) an injection pressure signal, and iii) an injection rate signal.

6. Apparatus according to claim 1, further comprising a active material actuator configured to be disposed between the core and the core plate, and configured to receive actuator signals and apply a responsive force between the core and the core plate.

7. Apparatus according to claim 6, wherein said active material actuator comprises a piezoelectric actuator.

8. Apparatus according to claim 6, wherein said active material actuator is disposed adjacent said active material sensor, and wherein said active material sensor is configured to sense a change in a dimension of said active material actuator corresponding to a change in distance between the core and the core plate.

9. Apparatus according to claim 6, further comprising a plurality of active material actuators configured to be disposed at different locations between the core and the core plate.

10. Apparatus according to claim 9, wherein said plurality of active material actuators are configured to control a deflection of the core plate.

11. Apparatus according to claim 9, further comprising a plurality of active material sensors configured to be disposed at different locations between the core and the core plate, and wherein the injection molding machine includes a plurality of cores, and wherein at least one active material sensor and at least one active material actuator are configured to be disposed adjacent each core.

12. Apparatus according to claim 11, further comprising control structure configured to (i) receive sense signals from said plurality of active material sensors, and (ii) transmit actuator signals to said plurality of active material actuators.

13. Apparatus according to claim 12, wherein said control structure is configured to perform closed-loop control of pressure between the core and the core plate.

14. Control apparatus for an injection mold having a first surface and a second surface, comprising:
an active material sensor configured to be disposed between the first surface and the second surface of the injection molding machine, for sensing a compressive force between the first surface and the second surface and generating a corresponding sense signal; and
transmission structure configured to transmit, in use, the sense signal from said active material sensor.

15. Apparatus according to claim 14, further comprising an active material actuator configured to be disposed between the first surface and the second surface, for receiving an actuation signal and generating a corresponding force between the first surface and the second surface, and wherein said transmission structure is configured to transmit the actuation signal to said active material actuator.

16. Apparatus according to claim 15, wherein said active material sensor and said active material actuator each comprise a piezo-electric element.

17. Apparatus according to claim 16, further comprising a plurality of piezo-electric sensors and a plurality of piezo-electric actuators, each configured to be disposed between the first surface and the second surface.

18. Apparatus for controlling deflection between first and second surfaces of an injection molding machine, comprising:
a piezoceramic actuator configured to be disposed between the first and second surfaces of the injection molding machine, for receiving an actuation signal, and for generating an expansive force between the first and second surfaces; and
transmission structure configured to transmit an actuation signal to said piezoceramic actuator.

19. Apparatus according to claim 18, further comprising a piezoceramic sensor disposed adjacent said piezoceramic actuator, for detecting changes in a dimension of said piezoceramic actuator and generating sensor signals corresponding thereto.

20. Apparatus according to claim 19, further comprising processor structure for receiving the sensor signal from said piezoceramic sensor and transmitting a corresponding actuation signal to said piezoceramic actuator using closed lop control.

21. Apparatus according to claim 20, further comprising a plurality of piezoceramic sensors and a plurality of piezoceramic actuators, each configured to be disposed between the first and second surfaces of the injection mold.

22. A device configured to be disposed between two adjacent load-bearing surfaces of an injection molding machine, comprising:
a piezo-electric element configured to be disposed between the two adjacent load-bearing surfaces of the injection molding machine, said piezo-electric element being configured to perfom at least one of (i) sense a compressive force between the two adjacent load-bearing surfaces of the injection molding machine and produce a sense signal corresponding thereto, and (ii) receive an actuation signal and cause a distance between the two adjacent load-bearing surfaces of the injection molding machine to be adjusted; and
transmission structure configured to perform at least one of (i) receive the sense signal from the piezo-electric element, and (ii) provide the actuation signal to the piezo-electric element.

23. Apparatus for correcting core shifting in an injection molding machine having a core and a core plate, comprising:
a plurality of piezo-electric actuators configured to be disposed about a periphery of the core, each for generating an expansive force between the core and the core plate, each of said plurality of piezo-electric actuators configured to be separately controllable;
transmission structure configured to provide an actuation signal, in use, to each of said plurality of piezo-electric actuators; and
control structure configured to provide, in use, the actuation signals to selected ones of said plurality of piezo-electric actuators to correct for core shifting.

24. Apparatus according to claim 23, further comprising a plurality of piezo-electric sensors configured to be disposed about the periphery of the core, each for sensing a compressive force between the core and the core plate and generating a corresponding sense signal, and wherein said transmission structure is configure to transmit the sense signals to said control structure.

25. Apparatus according to claim 24, wherein each piezo-electric sensor is disposed adjacent a corresponding piezo-electric actuator.

26. A method of controlling an injection mold having a first surface and a second surface, comprising the steps of:
sensing a compressive force between the first surface and the second surface with an active element sensor disposed between the first surface and the second surface of the injection molding machine;
generating a sense signal corresponding to the sensed compressive force;
transmitting the sense signal from the active element sensor to a processor;
generating an injection molding machine control signal according to the transmitted sense signal.

27. A method according to claim 26, wherein the active element sensor comprises a piezo-electric sensor.

28. A method according to claim 26, wherein the control signal comprises at least one of (i) a clamping force signal, (ii) an injection pressure signal, and (iii) an injection rate signal.

29. A method according to claim 26, further comprising the steps of:
calculating an actuation signal corresponding to the transmitted sense signal; and
using the active material actuator to generate an expansive force between the first surface and the second surface corresponding to the actuation signal.

30. A method according to claim 29, wherein the active element actuator comprises a piezo-electric actuator.

31. A method according to claim 26, further comprising the step of disposing a plurality of piezoceramic sensors and a plurality of piezoceramic actuators between the first surface and the second surface.

32. A method of controlling an injection mold having a first surface and a second surface, comprising the steps of:
determining a force actuation signal to control a space between the first surface and the second surface;
transmitting the force actuation signal to a piezo-electric actuator disposed between the first surface and the second surface of the injection molding machine; and
using the piezo-electric actuator to generate an corresponding expansion force between the first surface and the second surface.

33. A method according to claim 32, further comprising the step of determining the force actuation signal from a previous molding operation.

34. A method according to claim 32, further comprising the steps of:
using the piezo-electric sensor to sense a compressive force between the first surface and the second surface;
generating a sense signal corresponding to the sensed compressive force; and
transmitting the sense signal from the piezo-electric sensor to a controller.

35. A method according to claim 34, further comprising the steps of:
using the piezo-electric sensor to detect dimension changes in the piezo-electric actuator, and to generate feedback signals corresponding to the detected width changes; and
real-time closed loop controlling the piezo-electric actuator in accordance with the feedback signals.

36. Apparatus for correcting core shifting in an injection mold having a core and a core plate, comprising:
a plurality of active material actuators configured to be disposed about a periphery of the core, each generating an expansive force between the core and the core plate when energized, each of said plurality of active material actuators configured to be separately controllable; and
control means configured to provide, in use, actuation signals to each of said plurality of active material actuators; and
a user interface configured to accept user input, wherein said user input is entered into said interface based on measurements taken from molded parts previously produced by said injection mold, and wherein said control means provides said actuation signals based on the user input.

37. Apparatus according to claim 36, further comprising a plurality of active material sensors configured to be disposed about the periphery of the core, each for sensing a compressive force between the core and the core plate and generating a corresponding sense signal, and wherein said transmission structure is configure to transmit the sense signals to said control structure.

38. Apparatus according to claim 37, wherein each active material sensor is disposed adjacent a corresponding active material actuator.

39. A mold for use in an injection molding machine, comprising:
a core plate;
a core half;
a cavity half; and
at least one active material element provided within said core half.

40. The mold of claim 39, wherein said at least one active material element comprises an actuator, and generates a force between said core plate and said core half.

41. The mold of claim 39, wherein said at least one active material element comprises a sensor which detects a force generated between said core plate and said core half.
